(19) United States
(12) Patent Application Publication
(10) Pub. No.: US 2026/0340910 A1
(43) Pub. Date: Oct. 29, 2026

(54) DIALOGUE DIGITAL HUMAN GENERATION METHOD AND APPARATUS, DEVICE, MEDIUM, AND PRODUCT

(71) Applicant: Beijing Youzhuju Network Technology Co., Ltd., Beijing (CN)

(72) Inventors: Xiaojie WANG, Beijing (CN); Hao LV, Beijing (CN); Hao YANG, Beijing (CN); Xiaomin SONG, Beijing (CN); Pengbin GUO, Beijing (CN); Chen LI, Beijing (CN); Huanhuan JIA, Beijing (CN); Yeteng TAN, Beijing (CN); Rong ZHAO, Beijing (CN); Weiwei ZHU, Beijing (CN); Yufeng GAO, Beijing (CN)

(21) Appl. No.: 19/661,594

(22) Filed: Apr. 28, 2026

(30) Foreign Application Priority Data
Apr. 29, 2025 (CN) 202510561018.7

(51) Int. Cl. G06T 11/60; G06F 3/0484; G06F 40/166; G06F 40/205; G06F 40/35; G06T 13/00

(52) U.S. Cl. CPC G06T 11/60; G06F 3/0484; G06F 40/166; G06F 40/205; G06F 40/35; G06T 13/00; G06T 2200/24

(57) ABSTRACT

Provided are a dialogue digital human generation method and apparatus, a device, a medium and a product, which relate to the field of computer technologies. The method includes: displaying a digital human generation interface; in response to a material adding operation generated in a script material area, obtaining a target script material; parsing material content of the target script material to obtain at least one dialogue character corresponding to the target script material and dialogue content corresponding to the at least one dialogue character, and displaying each dialogue character and dialogue content corresponding to the each dialogue character in the script material area; displaying, in a preview area, a digital human corresponding to the dialogue character; and in response to a digital human synthesis operation generated in a generation area, generating a target dialogue digital human matching the target script material according to the dialogue character and the dialogue content.

### CROSS-REFERENCE TO RELATED APPLICATIONS

The present application is based on and claims priority of CN Application No. 202510561018.7, filed on Apr. 29, 2025, the disclosure of which is incorporated by reference herein in its entirety.

### TECHNICAL FIELD

The present disclosure relates to the field of computer technology, and in particular, to a dialogue digital human generation method and apparatus, a device, a medium, and a product.

### BACKGROUND

At present, when a digital human is generated, a single-person voice-over scene is mainly focused on.

### SUMMARY

The present disclosure provides a dialogue digital human generation method and apparatus, a device, a medium, and a product to solve the problem of poor generation effect of a dialogue digital human.

In a first aspect, the present disclosure provides a dialogue digital human generation method, including: displaying a digital human generation interface, where the digital human generation interface includes a script material area, a preview area, and a generation area; obtaining a target script material in response to a material adding operation generated in the script material area; parsing material content of the target script material to obtain at least one dialogue character corresponding to the target script material and dialogue content corresponding to the at least one dialogue character, and displaying each dialogue character and dialogue content corresponding to the each dialogue character in the script material area; displaying a digital human corresponding to the dialogue character in the preview area; and generating a target dialogue digital human matching the target script material according to the dialogue character and the dialogue content in response to a digital human synthesis operation generated in the generation area.

In a second aspect, the present disclosure provides a dialogue digital human generation apparatus, including: an interface displaying module, configured to display a digital human generation interface, where the digital human generation interface includes a script material area, a preview area, and a generation area; a material adding module, configured to obtain a target script material in response to a material adding operation generated in the script material area; a material parsing module, configured to parse material content of the target script material to obtain at least one dialogue character corresponding to the target script material and dialogue content corresponding to the at least one dialogue character, and display each dialogue character and dialogue content corresponding to the each dialogue character in the script material area; a preview module, configured to display a digital human corresponding to the dialogue character in the preview area; and a digital human synthesis module, configured to generate a target dialogue digital human matching the target script material according to the dialogue character and the dialogue content in response to a digital human synthesis operation generated in the generation area.

In a third aspect, the present disclosure provides an electronic device, including: a memory and a processor, where the memory and the processor are communicatively connected to each other, the memory stores computer instructions, and the processor executes the computer instructions to perform the dialogue digital human generation method according to the first aspect or any implementation corresponding thereto.

In a fourth aspect, the present disclosure provides a computer-readable storage medium, where the computer-readable storage medium stores computer instructions, and the computer instructions are used to cause a computer to perform the dialogue digital human generation method according to the first aspect or any implementation corresponding thereto.

In a fifth aspect, the present disclosure provides a computer program product, including computer instructions, where the computer instructions are used to cause a computer to perform the dialogue digital human generation method according to the first aspect or any implementation corresponding thereto.

### BRIEF DESCRIPTION OF THE DRAWINGS

In order to more clearly describe the technical solutions in the specific implementations of the present disclosure or in the related art, the following briefly introduces the drawings that need to be used in the description of the specific implementations or the related art. Obviously, the drawings in the following description are some implementations of the present disclosure, and for those of ordinary skill in the art, other drawings may also be obtained from these drawings without creative efforts.

FIG. 1 is a schematic diagram of an application scenario according to an embodiment of the present disclosure;

FIG. 2 is a schematic flowchart of a dialogue digital human generation method according to an embodiment of the present disclosure;

FIG. 3 is a schematic diagram of a digital human generation interface according to an embodiment of the present disclosure;

FIG. 4 is another schematic diagram of a digital human generation interface according to an embodiment of the present disclosure;

FIG. 5 is a schematic diagram of a switching control for a dialogue character and an on-camera character according to an embodiment of the present disclosure;

FIG. 6 is a schematic diagram of modification of dialogue content according to an embodiment of the present disclosure;

FIG. 7 is another schematic diagram of a digital human generation interface according to an embodiment of the present disclosure;

FIG. 8 is a schematic diagram of parsing progress of a target script material according to an embodiment of the present disclosure;

FIG. 9 is a schematic diagram of verification of dialogue content according to an embodiment of the present disclosure;

FIG. 10 is a schematic diagram of a newly created dialogue character according to an embodiment of the present disclosure;

FIG. 11 is a schematic diagram of prohibition of creation of a same dialogue character according to an embodiment of the present disclosure;

FIG. 12 is a schematic diagram of portrait customization according to an embodiment of the present disclosure;

FIG. 13 is a schematic diagram of background customization according to an embodiment of the present disclosure;

FIG. 14 is a schematic diagram of voice-over customization according to an embodiment of the present disclosure;

FIG. 15 is a schematic diagram of preview of an portrait, a background, and a voice-over according to an embodiment of the present disclosure;

FIG. 16 is a schematic diagram of a character identifier and character editing of a dialogue character according to an embodiment of the present disclosure;

FIG. 17 is a schematic diagram of digital human switching according to an embodiment of the present disclosure;

FIG. 18 is a schematic design diagram of dialogue content, an on-camera character switching control, and a dialogue character switching control according to an embodiment of the present disclosure;

FIG. 19 is a schematic diagram of different states of dialogue content according to an embodiment of the present disclosure;

FIG. 20 is a schematic diagram of adjustment of a display layout according to an embodiment of the present disclosure;

FIG. 21 is a schematic diagram of adjustment of a playback progress according to an embodiment of the present disclosure;

FIG. 22 is a schematic diagram of adjustment of display of a subtitle according to an embodiment of the present disclosure;

FIG. 23 is a schematic diagram of digital human loading according to an embodiment of the present disclosure;

FIG. 24 is a schematic diagram of digital human removal according to an embodiment of the present disclosure;

FIG. 25 is a schematic diagram of a newly created character according to an embodiment of the present disclosure;

FIG. 26 is a block diagram of a dialogue digital human generation apparatus according to an embodiment of the present disclosure; and

FIG. 27 is a schematic hardware structure diagram of an electronic device according to an embodiment of the present disclosure.

### DETAILED DESCRIPTION OF EMBODIMENTS

In order to make objectives, technical solutions, and advantages of embodiments of the present disclosure clearer, the technical solutions in the embodiments of the present disclosure are clearly and completely described below with reference to the drawings in the embodiments of the present disclosure. Apparently, the described embodiments are some rather than all of the embodiments of the present disclosure. All other embodiments obtained by those of ordinary skill in the art based on the embodiments of the present disclosure without paying any creative effort shall fall within the protection scope of the present disclosure.

It may be understood that before the technical solutions disclosed in the embodiments of the present disclosure are used, users shall be informed of the type, range of use, use scenarios, etc., of personal information involved in the present disclosure and the authorization of the users shall be obtained in an appropriate manner in accordance with relevant laws and regulations.

For example, in response to receiving an active request from a user, prompt information is sent to the user to clearly inform the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It may be understood that the above process of notifying and obtaining user authorization is only illustrative and does not limit the implementations of the present disclosure, and other manners that satisfy the relevant laws and regulations may also be applied to the implementations of the present disclosure.

It may be understood that the data involved in the technical solutions (including but not limited to the data itself, acquisition or use of the data) shall comply with requirements of corresponding laws, regulations, and related provisions.

At present, when a digital human is generated, a single-person voice-over scene is mainly focused on. Although tools for multiple digital humans in one video exist, these tools either simply concatenate the multiple digital humans, which results in a poor interaction effect between the digital humans and does not support switching of on-camera persons, or adopt a multi-track editing interaction mode, which leads to a high threshold for use, or have a PPT-style layout, in which it is difficult to accurately determine the corresponding relationship between a picture and each sentence. Thus, an effect of scene dialogue in a video is affected.

Although multiple digital humans exist in one video, the multiple digital humans are simply concatenated, and it is difficult to accurately determine the corresponding relationship between a video picture and dialog, which affects an effect of scene dialogue in the video. Therefore, how to realize intelligent generation of a dialogue digital human becomes an urgent technical problem.

According to the dialogue digital human generation method and apparatus, the device, the medium, and the product provided by embodiments of the present disclosure, a digital human generation interface is provided for a user to add a script material, preview a digital human, and generate a dialogue digital human on the digital human generation interface. In this way, the dialogue character and the dialogue content thereof may be directly and automatically parsed only by acquiring the target script material, and after the parsing is completed, the corresponding digital human is displayed in the preview area in turn according to interaction of each of the dialogue characters. When it is determined that the generation of the digital human meets requirements, the target dialogue digital human matching the dialogue character and the dialogue content is directly generated according to the dialogue character and the dialogue content, which realizes intelligent generation of the dialogue digital human and reduces manual editing costs. Moreover, each dialogue character may be accurately matched with the dialogue content thereof, which realizes an effect of scene dialogue of multiple dialogue characters, so that a relationship between a video picture and the dialogue content may be accurately corresponded.

In view of this, the technical solutions of the present disclosure provide a unified digital human generation interface, in which a script material only needs to be added to the digital human generation interface, a dialogue character may be automatically parsed, and dialogue content corresponding to the dialogue character may be automatically matched. Cognitive costs and a threshold of digital human generation are reduced through a unified framework, multi-dialogue character scene dialogue and single-character voice-over may be directly generated, and accurate matching between each dialogue character and the dialogue content thereof is ensured, which realizes intelligent generation of a dialogue digital human.

As an optional application scenario of an embodiment of the present disclosure, as shown in FIG. 1, the application scenario includes a digital human creation application 101 and an electronic device 102, and the digital human creation application 101 is deployed on the electronic device 102. In FIG. 1, only a limited number of components and exemplary connection relationships are shown. It should be understood that this is for the convenience of explanation and illustration and is not intended to limit the scope of the present disclosure, and there may be other different components. For example, a display component, an input component, and the like may be included. By way of example rather than limitation, a diagnostic result of a target page may be displayed on the display component, and a problem description, a problem type, etc. may be adjusted through the input component.

According to the embodiment of the present disclosure, a user may add a script material through a digital human generation interface 103 provided by the digital human creation application 101, and the digital human creation application 101 may automatically parse the script material and determine a dialogue character and dialogue content corresponding thereto, thereby realizing intelligent generation of a dialogue digital human according to the dialogue character and the dialogue content.

The electronic device 102 represents a device having computing resources or computing power and may be a device having computing power. For example, the electronic device may be provided with a processor, a memory, etc., and may also be equipped with a dedicated accelerator (such as a graphics processing unit (GPU), etc.). In addition, the electronic device may store and maintain data. Examples of the electronic device 102 may include a supercomputer, a personal computer, a laptop computer, an in-vehicle computing device, a mobile device (such as a smartphone, a tablet computer, etc.), or a combination including any one or more of the above devices, etc. It should be understood that the computer device described herein is only exemplary and non-limiting, and for example, other different types of computer devices may also be used.

According to an embodiment of the present disclosure, an embodiment of a dialogue digital human generation method is provided. It should be noted that the steps shown in the flowchart of the drawings may be performed in a computer system such as a set of computer executable instructions, and although a logical order is shown in the flowchart, in some cases, the steps shown or described may be performed in an order different from that herein.

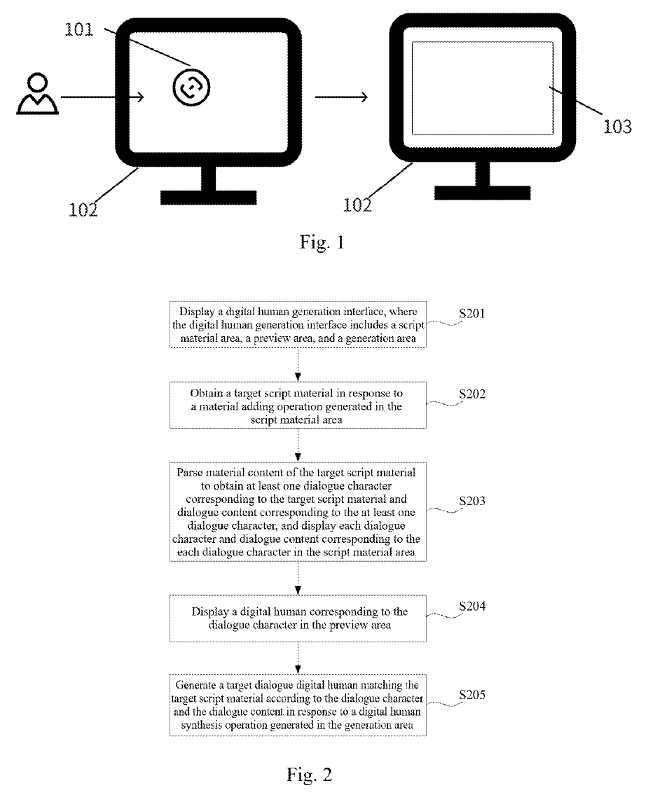

In this embodiment, a dialogue digital human generation method is provided, which may be applied to an electronic device, such as a computer, a mobile phone, a tablet computer, etc. FIG. 2 is a flowchart of a dialogue digital human generation method according to an embodiment of the present disclosure. As shown in FIG. 2, the flow includes the following steps.

Step S201: displaying a digital human generation interface, where the digital human generation interface includes a script material area, a preview area, and a generation area.

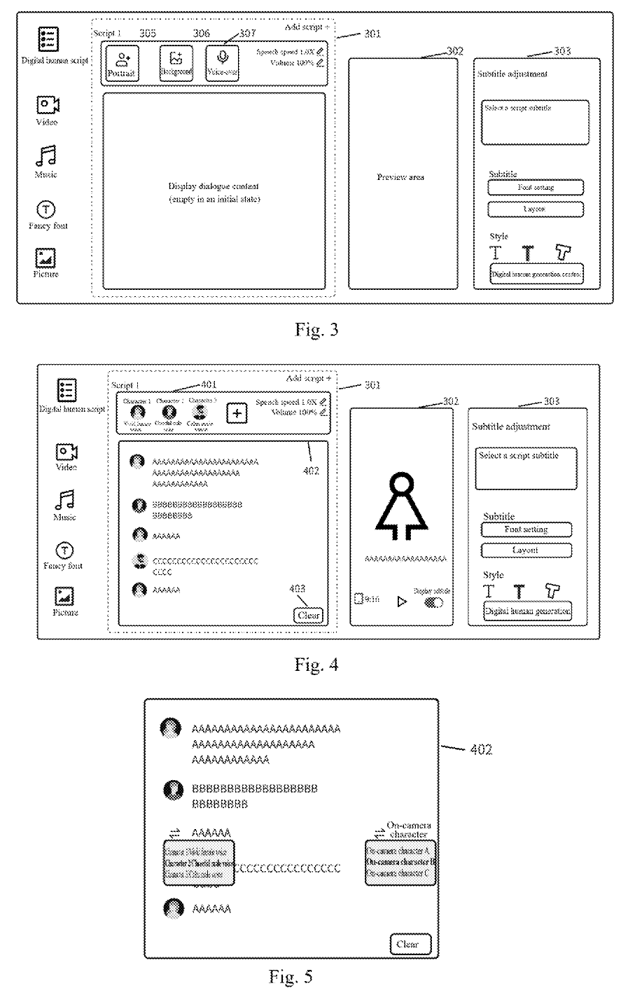

The digital human generation interface is a human-computer interaction interface provided by a digital human creation application. Specifically, the digital human creation application is installed in the electronic device, and a user may click on the digital human creation application to enter the digital human generation interface. As shown in FIG. 3, the digital human generation interface includes a script material area 301, a preview area 302, and a generation area 303. The script material area 301 is used for adding a script material, the preview area 302 is used for previewing a digital human generated for each dialogue character and dialogue content corresponding thereto, and the generation area 303 is used for generating a finished target dialogue digital human in a scene dialogue scene or a single-person voice-over scene according to the script material.

Step S202: obtaining a target script material in response to a material adding operation generated in the script material area.

The material adding operation is an operation of adding a script material triggered by the user in the script material area. The target script material is a script material used for generating a dialogue digital human, such as a scene dialogue material, a single-person voice-over material, etc. In a specific example, the user may trigger the material adding operation by clicking on a blank area of the script material area and upload the corresponding target script material according to the material adding operation. In another specific example, the user may trigger a material adding control in the script material area to trigger the material adding operation, so as to obtain the corresponding target script material according to the material adding operation.

Step S203: parsing material content of the target script material to obtain at least one dialogue character corresponding to the target script material and dialogue content corresponding to the at least one dialogue character, and displaying each dialogue character and dialogue content corresponding to each dialogue character in the script material area.

Different dialogue characters correspond to different dialogue content. The material content is content included in the target script material, and the material content includes at least one dialogue character and corresponding scene dialogue content. Specifically, the digital human creation application parses the target script material uploaded by the user to determine one or more dialogue characters included in the material content and dialogue content corresponding to each of the dialogue characters. Then, the parsed dialogue character(s) and the dialogue content thereof are displayed in the script material area, where different dialogue characters have different character identifiers, as shown in FIG. 4.

Step S204: displaying, in the preview area, a digital human corresponding to the dialogue character.

The digital human is an image visualization of the dialogue character, that is, the digital human may generate a corresponding body movement or mouth movement according to the dialogue content. Specifically, the preview area may display the corresponding digital human according to the dialogue character, or may also display the corresponding digital human and the dialogue content thereof according to the dialogue character, as shown in FIG. 4.

Step S205: generating a target dialogue digital human matching the target script material according to the dialogue character and the dialogue content in response to a digital human synthesis operation generated in the generation area.

The digital human synthesis operation is a fusion operation of the dialogue character and the dialogue content triggered by the user in the generation area. The target dialogue digital human is a dialogue digital human matching a scene of the target script material, and the target dialogue digital human may be a digital human in a single-person voice-over scene or multiple dialogue digital humans participating in dialogue in a scene dialogue scene.

Specifically, the user may preview the digital human(s) generated according to the target script material in the preview area and preview dialogue interaction between the digital human(s) according to the dialogue content. If it is determined that the generation of the digital human(s) and the interaction between the digital human(s) meet requirements, the generation of the target dialogue digital human may be triggered by clicking on a generation control in the generation area, so as to quickly synthesize materials according to each of the dialogue characters and the dialogue content corresponding thereto, to obtain the target dialogue digital human in the corresponding scene.

According to the dialogue digital human generation method provided by this embodiment, a digital human generation interface is provided for a user to add a script material, preview a digital human, and generate a dialogue digital human on the digital human generation interface. In this way, the dialogue character and the dialogue content thereof may be directly and automatically parsed only by acquiring the target script material, and after the parsing is completed, the corresponding digital human is displayed in the preview area in turn according to interaction of each of the dialogue characters. When it is determined that the generation of the digital human meets requirements, the target dialogue digital human matching the dialogue character and the dialogue content is directly generated according to the dialogue character and the dialogue content, which realizes intelligent generation of the dialogue digital human and reduces manual editing costs. Moreover, each dialogue character may be accurately matched with the dialogue content thereof, which realizes an effect of scene dialogue of multiple dialogue characters, so that a corresponding relationship between a video picture and the dialogue content may be accurately determined.

In some optional implementations, displaying, in the script material area, a character identifier corresponding to the each dialogue character and dialogue content corresponding to the each dialogue character includes: displaying, in a character display area of the script material area, the character identifier corresponding to the each dialogue character; and displaying, in a content display area of the script material area, the dialogue content corresponding to the each dialogue character.

The character identifier is a character uniqueness identifier generated according to the dialogue character, and different dialogue characters have different character identifiers. The character display area is used for displaying the character identifier, and the content display area is used for displaying the dialogue content. Specifically, as shown in FIG. 4, the character display area 401 is disposed above the script material area, the character identifier of each dialogue character is displayed in the character display area 401, the dialogue characters included in the target script material are distinguished by the character identifier, and the character identifier of each dialogue character is displayed in the character display area 401 in a preset manner, for example, flat display as shown in FIG. 4. The content display area 402 is disposed below the character display area 401, and each dialogue character and the dialogue content corresponding thereto are displayed in the content display area 402.

In the above implementation, the character identifier corresponding to the dialogue character and the dialogue content are displayed in different areas, which facilitates the user to intuitively check the accuracy of the parsed dialogue character and the dialogue content thereof.

In some optional implementations, the above method further includes: displaying, at a first preset position of the character identifier, description information of the character identifier; and/or displaying, at a second preset position of the script material area, a character dialogue parameter.

The description information is an image description of the character identifier, and includes a character name of the character identifier, character audio information, etc. The first preset position is a preset position for displaying the description information. Specifically, as shown in FIG. 4, the character identifier of each dialogue character is displayed in the character display area 401, the character name is displayed above the character identifier, and the character audio information is displayed below the character identifier.

The character dialogue parameter represents a dialogue parameter of the dialogue character in a dialogue process, and includes a speaking speed, a volume, etc. The second preset position is a preset position for displaying the character dialogue parameter. Specifically, as shown in FIG. 4, the speaking speed, the volume, etc. required by the dialogue character in the dialogue process are displayed on the right side of the character display area 401. Moreover, the speaking speed of the dialogue character may be adjusted by triggering the speaking speed, and the volume of the dialogue character may be adjusted by triggering the volume.

In the above implementation, the description information of the character identifier and the character dialogue parameter are supported to be displayed, which facilitates direct understanding of a character attribute and a dialogue attribute of each dialogue character.

In some optional implementations, the above method further includes: updating a dialogue character corresponding to the dialogue content in response to a character switching operation for the dialogue content.

When any line of dialogue content is triggered, a character switching control is displayed at a preset position of the line of dialogue content (for example, on the left side of the dialogue content). The user performs the character switching operation by clicking on the character switching control. Correspondingly, the character switching control may respond to the click operation of the user to display a character list of all dialogue characters included in the target script material, and the user may update the dialogue character of the current line of dialogue content from the character list, as shown in FIG. 5, a dialogue character 1 is changed to a dialogue character 2.

In some optional implementations, the above method further includes: updating dialogue content corresponding to any dialogue character in response to a modification operation for the dialogue content of the dialogue character.

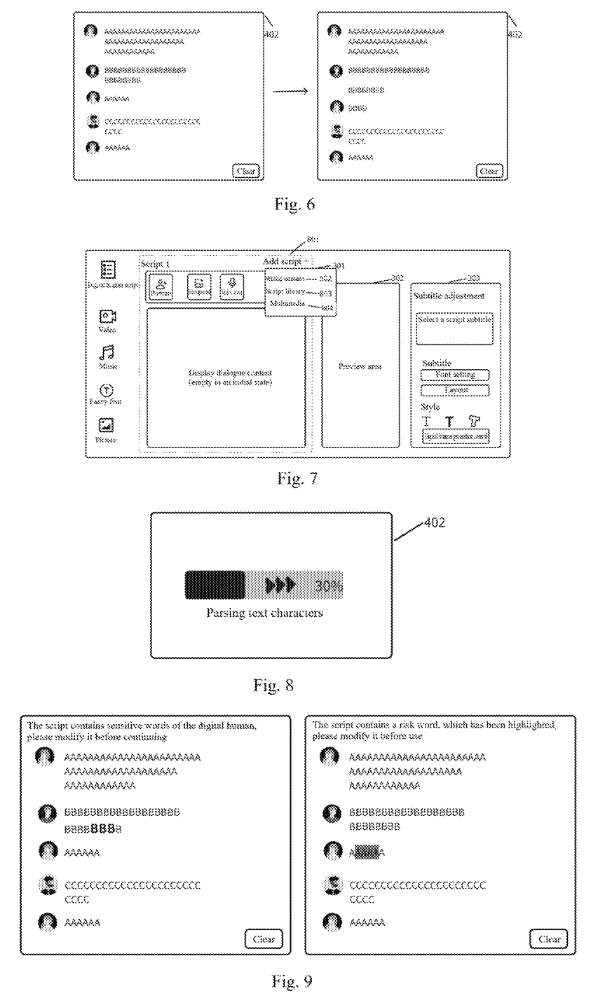

The modification operation is modification of the dialogue content of the triggered line, and includes setting a blank line, modifying content, etc. Specifically, when any line of dialogue content corresponding to any dialogue character is selected, the user may edit the line of dialogue content to update the dialogue content of the line, or may perform blank line setting for the line of dialogue content to deploy a blank dialogue line below the line of dialogue content, as shown in FIG. 6.

In the above implementation, the dialogue character corresponding to the dialogue content is supported to be changed, which realizes customized updating of the dialogue character and ensures the matching degree between the dialogue content and the dialogue character. The modification of the dialogue content is supported, which facilitates the modification of the dialogue content according to an actual dialogue scene and ensures the adaptation between the dialogue content and the dialogue scene.

In some optional implementations, the above method further includes: deleting the dialogue content and retaining configuration for the dialogue character in response to a clear operation for the dialogue content; and preferentially matching the corresponding dialogue content for the retained dialogue character when the script material is parsed again.

The content display area 402 is provided with a clear control 403, and the user triggers the clear operation for the dialogue content by clicking on the clear control 403, as shown in FIG. 4. After it is detected that the user triggers the clear control 403, a secondary confirmation interface is popped up, and if the user confirms to clear for the second time, all dialogue content in the content display area 402 is deleted, and at the same time, the configuration of the current existing dialogue character is retained.

After the target script material is acquired again, the target script material is pasted into the script material area for material parsing, to obtain dialogue content corresponding to different dialogue characters, and the dialogue content is matched with the retained dialogue character. If the number of retained dialogue characters does not satisfy the number of dialogue characters required by the dialogue content, a new dialogue character is added to match the dialogue content.

In the above implementation, the dialogue content is supported to be cleared, and the existing dialogue character configuration is retained when the dialogue content is cleared, which avoids subsequent reconfiguration, saves configuration time of the dialogue character, and improves parsing efficiency of the script material.

In some optional implementations, as shown in FIG. 7, the script material area includes a script adding control 801, and accordingly, the above step S202 includes:
Step a1: displaying a script material adding interface in response to a trigger operation for the script adding control, where the script material adding interface includes at least one of a writing assistance control, a script library control, and a multimedia control.
Step a2: displaying at least one candidate script material in response to a trigger operation for the script library control, and obtaining the target script material in response to a selection operation for the candidate script material; and/or
Step a3: displaying a script editing page in response to a trigger operation for the writing assistance control, and generating the target script material according to a target script parameter determined by a script parameter editing operation in response to the script parameter editing operation generated in the script editing page; and/or
Step a4: displaying at least one candidate multimedia material in response to a trigger operation for the multimedia control, obtaining a target multimedia material in response to a selection operation for the candidate multimedia material, and determining the target multimedia material as the target script material.

As shown in FIG. 7, the script material area is provided with a script adding control 801, and the user may click on the script adding control 801 to trigger the script material adding operation. Correspondingly, the script adding control 801 may respond to the click operation of the user to display the script material adding interface, and the script material adding interface is provided with a writing assistance control 802, a script library control 803, and a multimedia control 804, as shown in FIG. 7.

Specifically, if the user triggers the writing assistance control 802, a script editing page is displayed. The script editing page is provided with multiple script parameters to be edited, and the user may edit each of the script parameters in the script editing page to obtain corresponding target script parameters. Then, the writing assistance control 802 may use the target script parameters as prompt information, and use the prompt information to guide a material generation model corresponding to the writing assistance control 802 to generate a target script material matching the target script parameters.

If the user triggers the script library control 803, a display interface of a script material set is displayed, and the script material set is provided with multiple candidate script materials. The user may select a required target script material from the multiple candidate script materials.

If the user triggers the multimedia control 804, a display interface of a multimedia material set is displayed, and the multimedia material set is provided with multiple candidate multimedia materials. The candidate multimedia material may be an audio material, a video material, or an image material, which is not specifically limited here. The user may select a required target multimedia material from the multiple candidate multimedia materials and determine the selected target multimedia material as the target script material.

In the above implementation, the target script material is supported to be generated through the writing assistance control, the script library control, and the multimedia control, which improves the generation diversification of the target script material.

In some optional implementations, when parsing the material content of the target script material, the above method further includes: displaying, in the script material area, a parsing progress of the target script material and parsing prompt information.

The parsing progress is used for representing a parsing progress of the target script material, such as 50%, 80%, etc. The parsing prompt information represents description information generated for the parsing progress.

As shown in FIG. 8, if the target script material includes multiple dialogue characters, in the process of parsing the target script material, corresponding parsing prompt information such as "understanding script content", "parsing text characters", "splitting dialogue content", "matching character images", and "automatically splitting lines" is displayed in turn according to the parsing progress.

If the target script material includes only one dialogue character (that is, a single character), in the process of parsing the target script material, corresponding parsing prompt information such as "understanding script content", "parsing text characters", "matching character images", and "automatically splitting lines" is displayed in turn according to the parsing progress.

If the target script material is a multimedia script material, in the process of parsing the target script material, corresponding parsing prompt information such as "separating audio", "converting copywriting", "understanding copywriting", "matching character images", and "automatically splitting lines" is displayed in turn according to the parsing progress.

In the above implementation, the user experience is improved by displaying the parsing progress and the parsing prompt information.

In some optional implementations, after completing the material content parsing for the target script material, the above method may further include:
Step b1: verifying the parsed dialogue content and generating a verification result.
Step b2: if the verification result represents that the dialogue content includes non-compliant content, generating prompt information for the non-compliant content.

The verification result is used for representing whether the parsed dialogue content includes non-compliant content. If the verification result represents that the dialogue content includes non-compliant content, corresponding prompt information is displayed according to the non-compliant content, such as "the script contains sensitive words of the digital human, please modify it before continuing" and "the script contains a risk word, which has been highlighted, please modify it before use" as shown in FIG. 9.

It should be noted that when there is non-compliant content, the generation control in the generation area is set to a disabled state, and when the user triggers the generation control, it is prompted to pay attention to the script error.

It should be noted that if the parsing fails due to a network or other reasons, corresponding prompt information, such as "unstable network leads to parsing interruption, it is recommended to try again later", will be generated in the content display area 402 of the script material area.

In the above implementation, the dialogue content is verified, so as to prompt the non-compliant content, and the compliance and security of the parsed dialogue content are ensured.

In some optional implementations, as shown in FIG. 12, the script material area is provided with a character adding control 404, and a new dialogue character is added through the character adding control 404. Correspondingly, the above method further includes:
Step c1: displaying a character configuration interface in response to a trigger operation for the character adding control, where the character configuration interface includes an portrait configuration control, a background configuration control, and a voice-over configuration control.
Step c2: displaying at least one candidate portrait in response to a trigger operation for the portrait configuration control, and determining a target portrait in response to a selection operation for the candidate portrait .
Step c3: displaying at least one candidate background in response to a trigger operation for the background configuration control, and determining a target background in response to a selection operation for the candidate background.
Step c4: displaying at least one candidate voice-over in response to a trigger operation for the voice-over configuration control, and determining a target voice-over in response to a selection operation for the candidate voice-over.
Step c5: fusing the target portrait, the target background, and the target voice-over to create a digital human corresponding to the dialogue character.

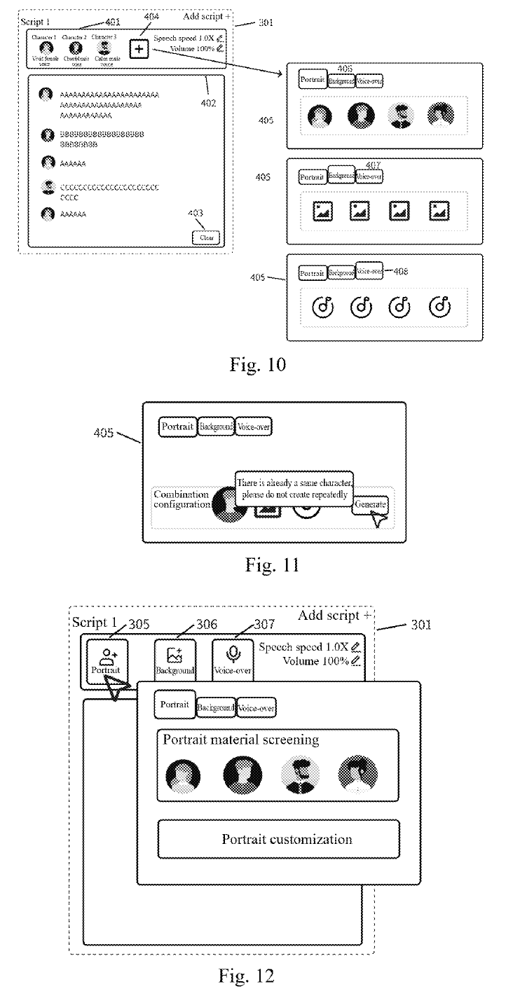

As shown in FIG. 10, the script material area is provided with the character adding control 404, and the user may click on the character adding control 404 to trigger the creation of the dialogue character. Correspondingly, the character adding control 404 may respond to the click operation of the user to display the character configuration interface 405, and the character configuration interface 405 is provided with the portrait configuration control 406, the background configuration control 407, and the voice-over configuration control 408. The setting positions of the portrait configuration control 406, the background configuration control 407, and the voice-over configuration control 408 may be set according to actual needs, and are not specifically limited here. As shown in FIG. 10, the portrait configuration control 406, the background configuration control 407, and the voice-over configuration control 408 may be disposed at the top of the character configuration interface 405.

Specifically, as shown in FIG. 10, if the user triggers the portrait configuration control 406, a candidate portrait set is displayed, and the candidate portrait set is provided with multiple candidate portraits. The user may select a candidate portrait of interest from the multiple candidate portraits as the target portrait.

As shown in FIG. 10, if the user triggers the background configuration control 407, a candidate background set is displayed, and the candidate background set is provided with multiple candidate backgrounds. The user may select a candidate background of interest from the multiple candidate backgrounds as the target background.

As shown in FIG. 10, if the user triggers the voice-over configuration control 408, a candidate voice-over set is displayed, and the candidate voice-over set is provided with multiple candidate voice-overs. The user may select a candidate voice-over of interest from the multiple candidate voice-overs as the target voice-over.

Correspondingly, the target portrait, the target background, and the target voice-over are combined and configured to complete the creation of the digital human corresponding to the dialogue character.

In the above implementation, the dialogue character is supported to be adaptively configured according to the portrait configuration control, the background configuration control, and the voice-over configuration control, which improves the creation flexibility of the dialogue character.

In some optional implementations, the above method further includes: when the creation of a same dialogue character is detected, prohibiting the creation of the same dialogue character, and generating creation prompt information for the same dialogue character.

It is detected whether the currently created dialogue character is the same as an existing dialogue character in terms of image, background and voice-over. If it is determined that the currently created dialogue character is the same as the existing dialogue character in terms of image, background and voice-over, it indicates that the currently created dialogue character and the existing dialogue character belong to the same character. At this time, the character generation control is controlled to be in a disabled state to prohibit the creation of the same dialogue character, as shown in FIG. 11. At the same time, when the user triggers the character generation control (for example, hovering over the character generation control), corresponding creation prompt information is generated, such as "there is already a same character, please do not create repeatedly".

In the above implementation, the creation accuracy of the dialogue character is ensured by prohibiting the creation of the same dialogue character.

In some optional implementations, the above method further includes:
Step d1: displaying a character configuration interface in response to a selection operation for the dialogue character, where the character configuration interface includes an portrait configuration control, a background configuration control, and a voice-over configuration control.
Step d2: obtaining an updated dialogue character in response to a character configuration modification generated in the character configuration interface, where the character configuration modification includes at least one of a portrait modification, a background modification, and a voice-over modification.

When the user selects the character identifier corresponding to any created dialogue character, the character configuration interface 405 is displayed, and the character configuration interface 405 is provided with the portrait configuration control 406, the background configuration control 407, and the voice-over configuration control 408. The portrait configuration control 406 is used for updating an image parameter, the background configuration control 407 is used for updating a background parameter, and the voice-over configuration control 408 is used for updating a voice-over parameter, as shown in FIG. 10.

When the user triggers any one of the portrait configuration control 406, the background configuration control 407 and the voice-over configuration control 408, the portrait modification, the background modification or the voice-over modification for the dialogue character is triggered, to obtain the dialogue character with the modified character configuration.

In the above implementation, the portrait modification, the background modification and the voice-over modification are supported for the dialogue character, which improves the modification flexibility of the dialogue character.

In some optional implementations, as shown in FIG. 3, when the dialogue character is created for the first time, the script material area includes an portrait initialization control 305, a background initialization control 306, and a voice-over initialization control 307. Correspondingly, the above method further includes:
Step e1: displaying a portrait configuration interface in the character configuration interface in response to a trigger operation for the portrait initialization control, and performing portrait customization according to a target portrait parameter determined by a portrait parameter configuration operation in response to the portrait parameter configuration operation generated in the portrait configuration interface, to generate an initialization character portrait.
Step e2: displaying a background configuration interface in the character configuration interface in response to a trigger operation for the background initialization control, and performing background customization according to a target background parameter determined by a background parameter configuration operation in response to the background parameter configuration operation generated in the background configuration interface, to generate an initialization background.
Step e3: displaying a voice-over configuration interface in the character configuration interface in response to a trigger operation for the voice-over initialization control, and performing voice-over customization according to a target voice-over parameter determined by a voice-over parameter configuration operation in response to the voice-over parameter configuration operation generated in the voice-over configuration interface, to generate an initialization voice-over.
Step e4: obtaining the dialogue character created for the first time based on a fusion configuration of the initialization character portrait, the initialization background, and the initialization voice-over.

The setting positions of the portrait initialization control 305, the background initialization control 306, and the voice-over initialization control 307 may be set according to actual needs, and are not specifically limited here. As shown in FIG. 3, the portrait initialization control 305, the background initialization control 306, and the voice-over initialization control 307 may be disposed at the top of the script material area.

When the dialogue character is created for the first time, if the user triggers the portrait initialization control 305, the portrait configuration interface is displayed in the character configuration interface, and the portrait configuration interface includes multiple candidate portraits and image parameter configuration for each of the candidate portraits. The user may configure the image parameter in the portrait configuration interface. Correspondingly, the portrait configuration interface may respond to portrait parameter configuration operations such as portrait material screening and portrait customization generated in the portrait configuration interface, determine the corresponding target portrait parameter, and perform portrait customization according to the target portrait parameter to generate the initialization character portrait, as shown in FIG. 12.

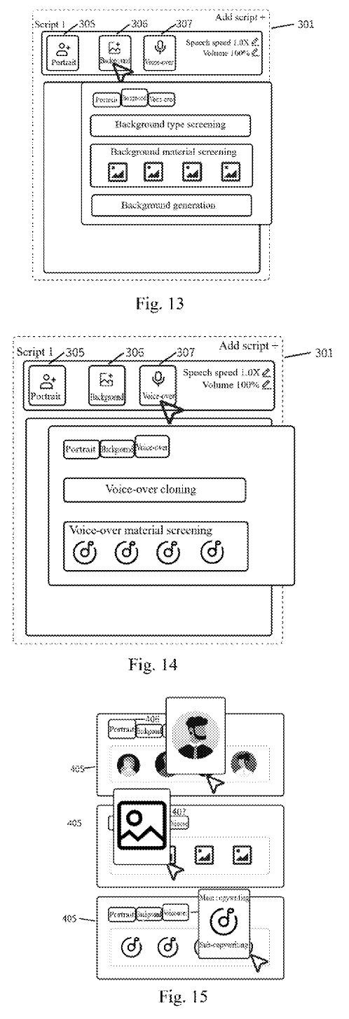

If the user triggers the background initialization control 306, the background configuration interface is displayed in the character configuration interface, and the background configuration interface includes multiple candidate backgrounds and background parameter configuration for each of the candidate backgrounds. The user may configure the background parameter in the background configuration interface. Correspondingly, the background configuration interface may respond to background parameter configuration operations such as background type screening, background material screening and background generation generated in the background configuration interface, determine the corresponding target background parameter, and perform background customization according to the target background parameter to generate the initialization background, as shown in FIG. 13.

If the user triggers the voice-over initialization control 307, the voice-over configuration interface is displayed in the character configuration interface, and the voice-over configuration interface includes multiple candidate voice-overs and voice-over parameter configuration for each of the candidate voice-overs. The user may configure the voice-over parameter in the voice-over configuration interface. Correspondingly, the voice-over configuration interface may respond to voice-over parameter configuration operations such as voice-over cloning and voice-over material screening generated in the voice-over configuration interface, determine the corresponding target voice-over parameter, and perform background customization according to the target voice-over parameter to generate the initialization voice-over, as shown in FIG. 14.

Correspondingly, the initialization character portrait, the initialization background, and the initialization voice-over are combined and configured to complete the creation of the initialization dialogue character.

In the above implementation, the creation of the initialization dialogue character is supported according to the portrait initialization control, the background initialization control, and the voice-over initialization control, so as to realize the customized generation of the dialogue character.

In some optional implementations, the above method further includes: previewing an action of a current portrait in response to a trigger operation for the current portrait.

As shown in FIG. 15, in the process of browsing each portrait in the portrait configuration interface, when browsing to an portrait of interest, a preset time (such as 300 ms) may be hovered over the current portrait, so that the action effect of the current portrait may be previewed.

In some optional implementations, the above method further includes: previewing a current background in response to a trigger operation for the current background; and if there is a selected portrait, performing a combination preview of the selected portrait and the current background.

As shown in FIG. 15, in the process of browsing each background in the background configuration interface, when browsing to a background of interest, a preset time (such as 300 ms) may be hovered over the current background, so that the current background may be previewed in a large picture. Further, if there is currently a selected portrait, the selected portrait is fused with the current background, and the fused result is previewed. Certainly, the preview here may be dynamic or static, and those skilled in the art may determine it according to actual needs.

In some optional implementations, the above method further includes: playing a current voice-over and displaying timbre attribute information corresponding to the current voice-over in response to a selection operation for the current voice-over.

As shown in FIG. 15, in the process of browsing each voice-over in the voice-over configuration interface, when browsing to a voice-over of interest, the current voice-over may be selected. At this time, the current voice-over is played, and a voice-over identifier (such as a voice-over avatar) corresponding to the current voice-over is moved upward, and the timbre attribute information is displayed below the voice-over identifier. The timbre attribute information is used for representing timbre characteristics of the current voice-over, and includes main copywriting information (such as a vibrant female voice, etc.) and sub-copywriting information (such as relaxed and bright, etc.). When the length of the timbre attribute information exceeds a preset length, only the content of the preset length is displayed. Certainly, the voice-over identifier (such as the voice-over avatar) may also be moved in other directions, and the timbre attribute information is displayed in other positions, which is not specifically limited here. Further, if there is no sub-copywriting, only the main copywriting information is displayed.

In the above implementation, the action of each portrait in the portrait configuration interface is supported to be previewed, so as to select a required portrait through preview; the action of each background in the background configuration interface is supported to be previewed, so as to select a required background through preview, and the combination preview of the background and the portrait is also supported, so as to determine whether the selected background and the selected portrait are adapted; and each voice-over in the voice-over configuration interface is supported to be played, so as to select a required voice-over through playing preview.

In some optional implementations, the above method further includes: displaying a character state of the dialogue character according to different trigger operations in response to the different trigger operations generated for the dialogue character; and editing the dialogue character in response to dialogue character editing operations generated in the different character states.

After the creation of the dialogue character is completed, the character identifier of the dialogue character has different trigger modes, and different trigger modes will display different character states. Therefore, in different character states, different editing operations may be performed on the character identifier. Specifically, if the character identifier is clicked and selected, the dialogue content corresponding to the character identifier is highlighted in the content display area 402, and then, the user may check whether the highlighted dialogue content is accurate, and if it is not accurate, the user may modify and adjust the dialogue content. If the mouse is hovered over the character identifier, operation controls for the dialogue character, such as a deletion control, an editing control, etc., are displayed, and then, the user may delete or modify the dialogue character.

In the above implementation, different character states are displayed by different triggers, so as to edit the dialogue character according to the different character states, thereby realizing flexible adjustment of the dialogue character.

In some optional implementations, the above method further includes: when the number of dialogue characters reaches a first preset value, displaying, at a first preset position of the script material area, character identifiers corresponding to the each dialogue character in a preset manner; and when the number of dialogue characters reaches a second preset value, prohibiting the deletion of the dialogue character.

The first preset value is a preset number of dialogue characters allowed to be created, such as 5. The second preset value is a preset minimum number of dialogue characters, such as 1. The preset manner is a display manner of the dialogue characters in the script material area, such as flat folding, independent management, etc. The first preset value, the second preset value, and the preset manner are not specifically limited here, and those skilled in the art may determine them according to actual needs.

As shown in FIG. 16, when the number of created dialogue characters reaches the first preset value, the character identifier corresponding to each dialogue character may be displayed in a manner of folding to the right, may be displayed in a manner of folding to the left, or may be displayed in a flat manner.

Since the dialogue character supports deletion, when the deletion of a certain dialogue character is triggered, a deletion secondary confirmation is popped up, and if the secondary confirmation is passed, the dialogue character is deleted. At the same time, whether the current number of dialogue characters reaches the second preset value is detected, and if the current number of dialogue characters reaches the second preset value, the deletion operation of the dialogue character will fail, that is, the dialogue character will not be deleted.

In the above implementation, the character identifiers of the multiple dialogue characters are displayed in the preset manner, so as to ensure the display effect of the multiple dialogue characters. The deletion of the dialogue character is supported, and when the number of dialogue characters reaches the second preset value, the deletion is prohibited, so as to ensure the configuration accuracy of the dialogue character.

In some optional implementations, displaying, in the preview area, the digital human corresponding to the dialogue character includes: obtaining a current triggered target dialogue content and a target dialogue character corresponding to the target dialogue content; and displaying, in the preview area, the digital human corresponding to the target dialogue character.

The user may browse the dialogue content in the content display area 402, and when the user needs to view the display of a certain sentence of dialogue in the preview area, the user may trigger the sentence of dialogue (that is, the target dialogue content). At this time, the target dialogue character corresponding to the sentence of dialogue is parsed, and the digital human corresponding to the target dialogue character is displayed in the preview area, as shown in FIG. 4.

In the above implementation, different digital humans are supported to be displayed according to different target dialogue characters, which improves the preview effect of the digital human.

In some optional implementations, the above method further includes: obtaining an on-camera character corresponding to a current triggered target dialogue content; determining a target on-camera character corresponding to the target dialogue content in response to a switching operation for the on-camera character in the script material area; and displaying, in the preview area, a digital human corresponding to the target on-camera character.

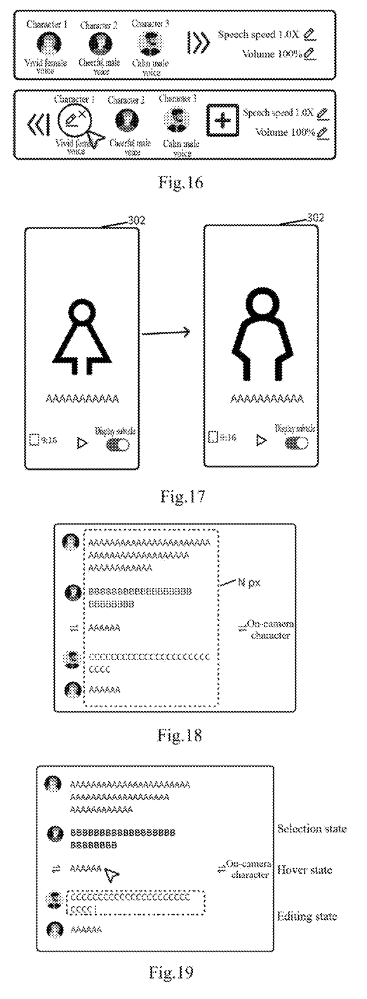

When any line of dialogue content (that is, the target dialogue content) is triggered, the on-camera character switching control is displayed at a preset position of the line of dialogue content (for example, on the right side of the dialogue content). The user performs the switching operation of the on-camera character by clicking on the on-camera character switching control. Correspondingly, the on-camera character switching control may respond to the click operation of the user to display the character list of all on-camera characters included in the target script material, and the user may update the on-camera character of the target dialogue content from the character list, as shown in FIG. 5, an on-camera character A is changed to an on-camera character B. Correspondingly, the preview area may be adaptively switched according to the switching of the on-camera character, that is, the digital human corresponding to the target on-camera character determined by the switching operation is displayed in the preview area, as shown in FIG. 17.

In the above implementation, the switching of the on-camera character is supported, which improves the flexible control of the on-camera character and ensures the dialogue effect displayed in the video picture.

In some optional implementations, the dialogue content is displayed in the content display area according to a first preset width (such as a fixed width of N px). The switching control of the on-camera character is adaptively right-aligned according to a second preset width (such as a width of 3 characters). The switching control of the dialogue character is adaptively aligned 2, as shown in FIG. 18.

In some optional implementations, for each line of dialogue in the dialogue content, the character identifier of the dialogue character may be displayed in front of each line of dialogue. When a dialogue character has multiple lines of dialogue, the character identifier of the dialogue character may also be displayed in the first line of dialogue, and not displayed in other lines.

Each line of dialogue has different trigger modes, and different trigger modes will display different states. Therefore, in different states, different operations may be performed on each line of dialogue. Specifically, if a certain line of dialogue content is clicked and selected, a selection state is entered, and at this time, the line of dialogue content is highlighted. If a certain line of dialogue content is double-clicked and selected, an editing state is entered, and at this time, the line of dialogue content may be edited. If the mouse is hovered over a certain line of dialogue content, the dialogue character switching control and the on-camera character switching control corresponding to the line of dialogue content may be displayed, as shown in FIG. 19.

In some optional implementations, as shown in FIG. 20, the preview area includes a layout control 501, a playback control 502, and a subtitle control 503. The layout control 501 is used for selecting a display layout, the playback control 502 is used for controlling action playback of the digital human, and the subtitle control 503 is used for controlling whether the dialogue content is displayed in the preview area.

Correspondingly, the above method further includes: switching a display layout of the preview area in response to a trigger operation for the layout control. As shown in FIG. 20, a layout list is displayed by triggering the layout control 501, and then a required layout may be selected from the layout list to update the display layout of the preview area.

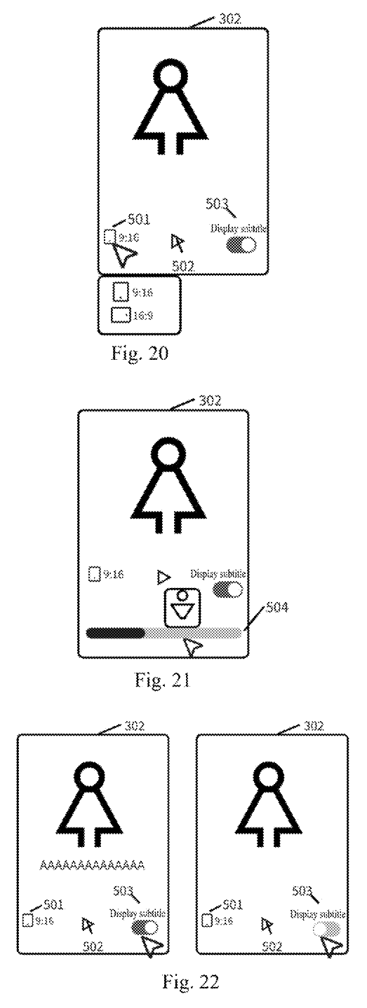

Correspondingly, the above method further includes: controlling an action playback of the target dialogue digital human in the preview area in response to a trigger operation for the playback control. As shown in FIG. 21, the playback and pause of the digital human in the preview area are controlled by triggering the playback control 502.

Correspondingly, the above method further includes: displaying the dialogue content in the preview area or turning off the display of the dialogue content in response to a trigger operation for the subtitle control. As shown in FIG. 22, when the subtitle control 503 is in a subtitle-on state, the display of the dialogue content in the preview area is turned off by triggering the subtitle control 503; and when the subtitle control 503 is in a subtitle-off state, the display of the dialogue content in the preview area is turned on by triggering the subtitle control 503.

In the above implementation, the switching of the display layout is supported, which facilitates the flexible adjustment of the display layout according to actual needs. The action playback control of the target dialogue digital human is supported, which realizes the flexible preview of the video picture where the target dialogue digital human is located. The turning on and off of the subtitle is supported, which facilitates the flexible control of the display of the dialogue content in the preview area.

In some optional implementations, the above method further includes: playing an action video of the target dialogue digital human and displaying a video playback progress control; jumping to a video frame specified by a progress adjustment operation in response to the progress adjustment operation generated on the video playback progress control; and/or displaying a preview image of a video frame specified by a progress adjustment trigger operation in response to the progress adjustment trigger operation generated on the video playback progress control.

As shown in FIG. 21, the action video of the target dialogue digital human is played in the preview area by triggering the playback control 502, and the corresponding video playback progress control 504 is displayed below the action video, and the playback state of the action video, such as playing, not playing, already played, etc., is represented by the playback progress control 504.

The video playback progress control 504 supports progress adjustment, such as dragging the progress bar to trigger the progress adjustment operation, and the preview area may jump to the playback position determined by the progress adjustment operation and display the video frame corresponding to the playback position.

The video playback progress control 504 also supports progress adjustment triggering, such as hovering over a certain position of the progress bar to implement the progress adjustment trigger operation, at this time, the preview image of the video frame specified by the progress adjustment trigger operation may be displayed above the video playback control in a manner of small image preview.

In the above implementation, jumping to the video frame specified by the progress adjustment operation is supported, which realizes the fast preview of the video. Displaying the preview image of the video frame specified by the progress adjustment trigger operation is supported, so as to jump to the video frame of interest for playing according to the preview image.

In some optional implementations, the above method further includes: displaying corresponding state prompt information in the preview area based on a loading state of the digital human; and/or generating prompt information that the digital human does not exist in the preview area when the digital human corresponding to the dialogue character is deleted.

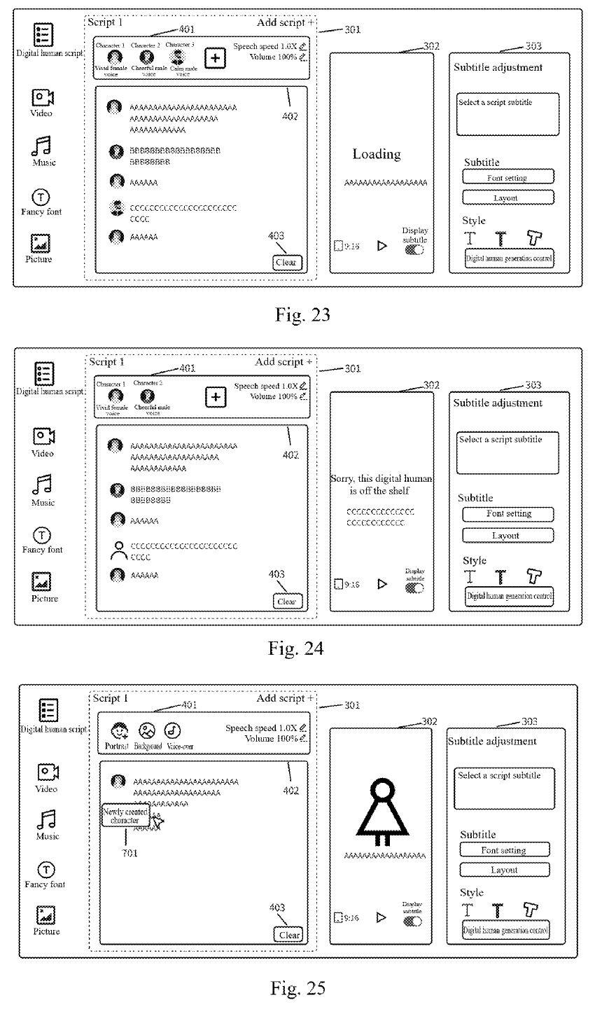

As shown in FIG. 23, after the parsing of the dialogue character and the dialogue content is completed, the digital human corresponding to each dialogue character is automatically generated. At this time, each digital human is displayed in the preview area according to the dialogue sequence of the dialogue content. When the digital human is being loaded, the playback control is in a disabled state, and the video playback progress control is in a "loading" state. At this time, when the digital human in the preview area is triggered, corresponding state prompt information, such as "audio is being generated, please wait", is displayed.

As shown in FIG. 24, when a certain dialogue character is deleted, its corresponding digital human will be deleted at the same time. Therefore, when the digital human is played again, the prompt information that the digital human does not exist, such as "sorry, this digital human is off the shelf", is generated in the preview area.

In the above implementation, the user's preview experience is improved by displaying the state prompt information of the digital human or the prompt information that the digital human does not exist in the preview area.

In some optional implementations, the above method further includes: when there is no target script material, displaying the preview area in a preset format, and displaying prompt information at a third preset position of the preview area, where the prompt information is used for prompting to add a material in the script material area.

As shown in FIG. 3, when there is no target script material, that is, when the target script material is created for the first time or the target script material is newly created, the preview area will be displayed in a preset format, such as a grid of light and dark. At the same time, the prompt information that the material needs to be added is displayed at the third preset position (such as the upper left corner) in the preview area, for example, "please input a script on the left to match the digital human first".

In the above implementation, the preview area is displayed according to the preset format, and the prompt information for adding the material is displayed in the preview area, which facilitates guiding the user to add the material and reduces the learning cost of generating the digital human.

In some optional implementations, the above method further includes: displaying the dialogue content in the preview area according to a subtitle parameter determined by a subtitle content adjustment operation in response to the subtitle content adjustment operation generated in the generation area.

As shown in FIG. 3, the generation area is provided with a corresponding subtitle content adjustment control, and the user may trigger the subtitle content adjustment operation through the subtitle content adjustment control, determine the subtitle parameter selected by the subtitle content adjustment operation, and display the dialogue content in the preview area according to the subtitle parameter.

In the above implementation, the dialogue content in the preview area is supported to be adjusted, so as to ensure the display effect of the dialogue content.

In some optional implementations, as shown in FIG. 4, the digital human generation interface includes a material parameter area, and the material parameter area includes multiple material controls, such as video, music, fancy font, picture, etc. Correspondingly, the above method further includes: displaying a candidate material in response to a trigger operation for the material control; and loading a selected target material into the preview area for display in response to a selection operation for the candidate material.

The user may trigger any one of the material controls, and accordingly, the material control may respond to the trigger operation of the user and display the corresponding candidate material. Then, the user may browse the candidate material and select the required target material from the candidate material, and accordingly, the target material will be loaded into the preview area and displayed in combination with the digital human.

In a specific example, the user triggers a picture material control, and accordingly, the picture material control may respond to the trigger operation of the user and display a corresponding candidate picture material. The user may select a required target picture material from the candidate picture material, and then, the target picture material will be loaded into the preview area and displayed in combination with the digital human.

Correspondingly, the above method further includes: displaying the target material in the preview area according to a material parameter determined by a material adjustment operation in response to the material adjustment operation generated in the generation area.

When the user triggers the target material in the preview area, the material parameter is echoed in the generation area. At this time, the user may fine-tune the material parameter of the target material in the generation area, and accordingly, the generation area may respond to the material adjustment operation of the user and determine the material parameter determined by the material adjustment operation. Then, the preview area may display the corresponding target material according to the material parameter.

It should be noted that when the user triggers the material control, the generation area simultaneously echoes the corresponding material adjustment control for the material control, and when the user selects the target material, the material may also be fine-tuned for the target material in the generation area.

In the above implementation, the target material is supported to be added to the dialogue digital human, which ensures the generation effect of the dialogue digital human. The modification of the target material is supported, which ensures that the target material in the dialogue digital human meets the requirements and improves the material richness of the generated dialogue digital human.

In some optional implementations, when the target script material is a single-character script material, the above method further includes: determining a target character parameter corresponding to the dialogue character in response to a switching operation for any parameter of the portrait, the background, and the voice-over of the dialogue character.

As shown in FIG. 25, when the target script material is a single-character script material, there is only one dialogue character, and for the dialogue character, the portrait, the background and the voice-over corresponding to the dialogue character are displayed in the script material area. The user may switch the portrait, the background or the voice-over corresponding to the dialogue character according to actual needs, and determine an portrait parameter, a background parameter and a voice-over parameter currently possessed by the dialogue character, and the portrait parameter, the background parameter and the voice-over parameter obtained after the switching are the target character parameter corresponding to the dialogue character. Then, the portrait, the background, and the voice-over corresponding to the dialogue character are displayed in the script material area according to the target character parameter corresponding to the dialogue character, and the digital human corresponding to the dialogue character displayed in the preview area is updated according to the portrait, the background and the voice-over corresponding to the target character parameter.

In the above implementation, for the single-character script material, the adjustment of the portrait, the background and the voice-over of the dialogue character is supported, which ensures the creation effect of the dialogue character.

In some optional implementations, when the target script material is a single-character script material, the above method further includes: creating a dialogue digital human corresponding to any line of dialogue content in response to a character creation operation for the any line of dialogue content.

When the target script material is a single-character script material, a dialogue character may also be newly created for any line of dialogue content. As shown in FIG. 25, when any line of dialogue content is triggered, a newly created character control 701 is displayed, and the user may click on the newly created character control 701 to trigger the character creation operation. Correspondingly, the character configuration interface is popped up, and in the character configuration interface, the corresponding portrait, background and voice-over are configured for the newly created dialogue character, the corresponding dialogue digital human is created according to the corresponding portrait, background and voice-over configured for the newly created dialogue character, and the dialogue digital human is displayed in the preview area. For the related operations of configuring the portrait, the background and the voice-over, refer to the related description corresponding to the above embodiment, which will not be repeated here.

In the above implementation, for the single-character script material, the creation of the dialogue character is supported, which realizes the flexible creation of the dialogue character, facilitates the adjustment of the single character to multiple dialogue characters, and realizes the effect of scene dialogue of multiple dialogue characters.

In this embodiment, a dialogue digital human generation apparatus is further provided, and the apparatus is configured to implement the above embodiment and preferred implementations, which will not be repeated here. As used below, the term "module" may implement a combination of software and/or hardware for a predetermined function. Although the apparatus described in the following embodiments is preferably implemented in software, implementation in hardware, or a combination of software and hardware is also possible and contemplated.

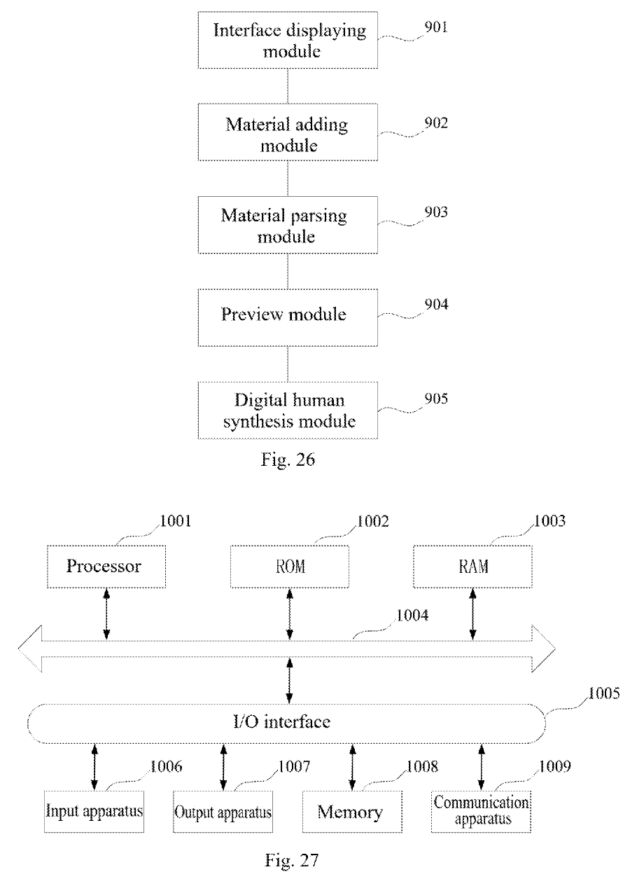

This embodiment provides a dialogue digital human generation apparatus, as shown in FIG. 26, including:
an interface displaying module 901, configured to display a digital human generation interface, where the digital human generation interface includes a script material area, a preview area, and a generation area;
a material adding module 902, configured to obtain a target script material in response to a material adding operation generated in the script material area;
a material parsing module 903, configured to parse material content of the target script material to obtain at least one dialogue character corresponding to the target script material and dialogue content corresponding to the at least one dialogue character, and display each dialogue character and dialogue content corresponding to the each dialogue character in the script material area;
a preview module 904, configured to display a digital human corresponding to the dialogue character in the preview area;
and a digital human synthesis module 905, configured to generate a target dialogue digital human matching the target script material according to the dialogue character and the dialogue content in response to a digital human synthesis operation generated in the generation area.

In some optional implementations, the material parsing module 903 includes:
a character identifier display unit, configured to display, in a character display area of the script material area, a character identifier corresponding to the each dialogue character; and
a dialogue content display unit, configured to display, in a content display area of the script material area, the dialogue content corresponding to the each dialogue character.

In some optional implementations, the above apparatus further includes:
an information display module, configured to display, at a first preset position of the character identifier, description information of the character identifier; and/or display, at a second preset position of the script material area, a character dialogue parameter.

In some optional implementations, the above apparatus further includes:
a character switching module, configured to update a dialogue character corresponding to the dialogue content in response to a character switching operation for the dialogue content; and
a content modification module, configured to update dialogue content corresponding to a dialogue character in response to a modification operation for the dialogue content of the dialogue character.

In some optional implementations, the above apparatus further includes:
a content clear module, configured to delete the dialogue content and retain configuration for the dialogue character in response to a clear operation for the dialogue content; and
a preferential matching module, configured to preferentially match the corresponding dialogue content for the retained dialogue character when the script material is parsed again.

In some optional implementations, the script material area includes a script adding control, and accordingly, the above material adding module 902 includes:
an interface display unit, configured to display a script material adding interface in response to a trigger operation for the script adding control, where the script material adding interface includes at least one of a writing assistance control, a script library control, and a multimedia control;
a script material determination unit, configured to display at least one candidate script material in response to a trigger operation for the script library control, and obtain the target script material in response to a selection operation for the candidate script material;
a script editing unit, configured to display a script editing page in response to a trigger operation for the writing assistance control, and generate the target script material according to a target script parameter determined by a script parameter editing operation in response to the script parameter editing operation generated in the script editing page; and
a multimedia material determination unit, configured to display at least one candidate multimedia material in response to a trigger operation for the multimedia control, obtain a target multimedia material in response to a selection operation for the candidate multimedia material, and determine the target multimedia material as the target script material.

In some optional implementations, the material parsing module 903 further includes:
a parsing state display unit, configured to display, in the script material area, a parsing progress of the target script material and parsing prompt information.

In some optional implementations, the material parsing module 903 further includes:
a verification unit, configured to verify the parsed dialogue content and generate a verification result; and
a first prompt unit, configured to: if the verification result represents that the dialogue content includes non-compliant content, generate prompt information for the non-compliant content.

In some optional implementations, the script material area includes a character adding control, and accordingly, the above apparatus further includes:
a first character configuration display module, configured to display a character configuration interface in response to a trigger operation for the character adding control, where the character configuration interface includes an portrait configuration control, a background configuration control, and a voice-over configuration control;
a target portrait determination module, configured to display at least one candidate portrait in response to a trigger operation for the portrait configuration control, and determine a target portrait in response to a selection operation for the candidate portrait;
a target background determination module, configured to display at least one candidate background in response to a trigger operation for the background configuration control, and determine a target background in response to a selection operation for the candidate background;
a target voice-over determination module, configured to display at least one candidate voice-over in response to a trigger operation for the voice-over configuration control, and determine a target voice-over in response to a selection operation for the candidate voice-over;
a fusing module, configured to fuse the target portrait, the target background, and the target voice-over to create the digital human corresponding to the dialogue character.

In some optional implementations, the above apparatus further includes:
a character disabling module, configured to: when the creation of a same dialogue character is detected, prohibit the creation of the same dialogue character, and generate prompt information for creation of the same dialogue character.

In some optional implementations, the above apparatus further includes:
a second character configuration display module, configured to display a character configuration interface in response to a selection operation for the dialogue character, where the character configuration interface includes an portrait configuration control, a background configuration control, and a voice-over configuration control; and
a character configuration change module, configured to obtain an updated dialogue character in response to a character configuration modification generated in the character configuration interface, where the character configuration modification includes at least one of a portrait modification, a background modification, and a voice-over modification.

In some optional implementations, when the dialogue character is created for the first time, the script material area includes an portrait initialization control, a background initialization control, and a voice-over initialization control, and the above apparatus further includes:
an portrait customization module, configured to display a portrait configuration interface in the character configuration interface in response to a trigger operation for the portrait initialization control, and perform portrait customization according to a target portrait parameter determined by an image parameter configuration operation in response to the image parameter configuration operation generated in the portrait configuration interface, to generate an initialization character image;
a background customization module, configured to display a background configuration interface in the character configuration interface in response to a trigger operation for the background initialization control, and perform background customization according to a target background parameter determined by a background parameter configuration operation in response to the background parameter configuration operation generated in the background configuration interface, to generate an initialization background;
a voice-over customization module, configured to display a voice-over configuration interface in the character configuration interface in response to a trigger operation for the voice-over initialization control, and perform voice-over customization according to a target voice-over parameter determined by a voice-over parameter configuration operation in response to the voice-over parameter configuration operation generated in the voice-over configuration interface, to generate an initialization voice-over; and
a configuration fusion module, configured to obtain the dialogue character created for the first time based on a fusion configuration of the initialization character portrait, the initialization background, and the initialization voice-over.

In some optional implementations, the above apparatus further includes:
a first previewing module, configured to preview an action of a current image in response to a trigger operation for the current portrait;
a second previewing module, configured to preview a current background in response to a trigger operation for the current background, and if there is a selected portrait, perform a combination preview of the selected portraitand the current background; and
a third previewing module, configured to play a current voice-over and display timbre attribute information corresponding to the current voice-over in response to a selection operation for the current voice-over.

In some optional implementations, the above apparatus further includes:
a character state display module, configured to display a character state of the dialogue character according to different trigger operations in response to the different trigger operations generated for the dialogue character; and
an editing module, configured to edit the dialogue character in response to a dialogue character editing operation generated in the different character states.

In some optional implementations, the above apparatus further includes:
a first display module, configured to: when the number of dialogue characters reaches a first preset value, display, at a first preset position of the script material area, a character identifier corresponding to the each dialogue character according to a preset manner; and
a deletion disabling module, configured to: when the number of dialogue characters reaches a second preset value, prohibit the deletion of the dialogue character.

In some optional implementations, the preview module 904 includes:
a target character obtaining unit, configured to obtain a target dialogue content currently triggered and a target dialogue character corresponding to the target dialogue content;
a digital human previewing unit, configured to display, in the preview area, the digital human corresponding to the target dialogue character.

In some optional implementations, the preview module 904 further includes:
an on-camera character obtaining unit, configured to obtain an on-camera character corresponding to the target dialogue content currently triggered;
an on-camera character switching unit, configured to determine a target on-camera character corresponding to the target dialogue content in response to a switching operation for the on-camera character in the script material area; and
an on-camera determination unit, configured to display, in the preview area, a digital human corresponding to the target on-camera character.

In some optional implementations, the preview area includes a layout control, a playback control, and a subtitle switch control, and the above apparatus further includes:
a layout determination module, configured to switch a display layout of the preview area in response to a trigger operation for the layout control;
a playback control module, configured to control an action playback of the target dialogue digital human in the preview area in response to a trigger operation for the playback control; and
a subtitle control module, configured to display the dialogue content in the preview area or turn off the display of the dialogue content in the preview area in response to a trigger operation for the subtitle control.

In some optional implementations, the above apparatus further includes:
a progress display module, configured to play an action video of the target dialogue digital human and display a video playback progress control;
a jumping module, configured to jump to a video frame specified by a progress adjustment operation in response to the progress adjustment operation generated on the video playback progress control; and
an image preview module, configured to display a preview image of a video frame specified by a progress adjustment trigger operation in response to the progress adjustment trigger operation generated on the video playback progress control.

In some optional implementations, the above apparatus further includes:
a state loading prompt module, configured to display corresponding state prompt information in the preview area based on a loading state of the digital human; and
a non-existence prompt module, configured to generate prompt information that the digital human does not exist in the preview area when the digital human corresponding to the dialogue character is deleted.

In some optional implementations, the above apparatus further includes:
a preview display control module, configured to: when there is no target script material, display the preview area in a preset format, and display prompt information at a third preset position of the preview area, where the prompt information is used for prompting to add a material in the script material area;

In some optional implementations, the above apparatus further includes:
a subtitle adjustment module, configured to display the dialogue content in the preview area according to a subtitle parameter determined by a subtitle content adjustment operation in response to the subtitle content adjustment operation generated in the generation area.

In some optional implementations, the digital human generation interface includes a material parameter area, and the material parameter area includes multiple material controls. The above apparatus further includes:
a candidate display module, configured to display a candidate material in response to a trigger operation for the material control; and
a target material determination module, configured to: load a selected target material into the preview area for display in response to a selection operation for the candidate material; and/or display the target material in the preview area according to a material parameter determined by a material adjustment operation in response to the material adjustment operation generated in the generation area.

In some optional implementations, when the target script material is a single-character script material, the above apparatus further includes:
a target parameter determination module, configured to determine a target character parameter corresponding to the dialogue character in response to a switching operation for any parameter of the image, the background, and the voice-over of the dialogue character; and
a character creation module, configured to create a dialogue digital human corresponding to any line of dialogue content in response to a character creation operation for the any line of dialogue content.

Further functional descriptions of the above modules and units are the same as the corresponding embodiments above, and will not be repeated here.

The dialogue digital human generation apparatus provided by the embodiment of the present disclosure may perform the dialogue digital human generation method provided by any embodiment of the present disclosure, and has corresponding functional modules and beneficial effects for performing the method. A digital human generation interface is provided for a user to add a script material, preview a digital human, and generate a dialogue digital human on the digital human generation interface. In this way, the dialogue character and the dialogue content thereof may be directly and automatically parsed only by acquiring the target script material, and after the parsing is completed, the corresponding digital human is displayed in the preview area in turn according to interaction of each of the dialogue characters. When it is determined that the generation of the digital human meets requirements, the target dialogue digital human matching the dialogue character and the dialogue content is directly generated according to the dialogue character and the dialogue content, which realizes intelligent generation of the dialogue digital human and reduces manual editing costs. Moreover, each dialogue character may be accurately matched with the dialogue content thereof, which realizes an effect of scene dialogue of multiple dialogue characters, so that a corresponding relationship between a video picture and the dialogue content may be accurately determined.

FIG. 27 is a schematic structural diagram of an electronic device provided by an embodiment of the present disclosure.

Reference is made specifically to FIG. 27 below, which illustrates a schematic structural diagram of an electronic device suitable for implementing the embodiments of the present disclosure. The electronic device may include a processor (such as a central processing unit, a graphics processor, etc.) 1001, which may perform various appropriate actions and processes according to a program stored in a read-only memory (ROM) 1002 or a program loaded from a memory 1008 into a random access memory (RAM) 1003. The RAM 1003 further stores various programs and data required for operations of the electronic device. The processor 1001, the ROM 1002, and the RAM 1003 are interconnected by means of a bus 1004. An input/output (I/O) interface 1005 is also connected to the bus 1004.

Usually, the following apparatuses may be connected to the I/O interface 1005: an input apparatus 1006 including, for example, a touch screen, a touchpad, a keyboard, a mouse, a camera, a microphone, an accelerometer, a gyroscope, etc.; an output apparatus 1007 including, for example, a liquid crystal display (LCD), a speaker, a vibrator, etc.; a memory 1008 including, for example, a magnetic tape, a hard disk, etc.; and a communication apparatus 1009. The communication apparatus 1009 may allow the electronic device to perform wireless or wired communication with other devices to exchange data. Although FIG. 27 shows the electronic device having various apparatuses, it should be understood that it is not required to implement or provide all of the illustrated apparatuses, and more or fewer apparatuses may be implemented or provided alternatively.

In particular, according to the embodiment of the present disclosure, the process described above with reference to the flowchart may be implemented as a computer software program. For example, the embodiment of the present disclosure includes a computer program product, which includes a computer program carried on a non-transitory computer-readable medium, where the computer program contains program codes for performing the method shown in the flowchart. In such an embodiment, the computer program may be downloaded and installed from a network via the communication apparatus 1009, or installed from the memory 1008, or installed from the ROM 1002. When the computer program is executed by the processor 1001, the above-mentioned functions defined in the dialogue digital human generation method of the embodiment of the present disclosure are executed.

The electronic device shown in FIG. 27 is only an example, and should not impose any limitation on the functions and scope of use of the embodiments of the present disclosure.

The embodiment of the present disclosure further provides a computer-readable storage medium, and the above method according to the embodiment of the present disclosure may be implemented in hardware and firmware, or implemented as computer codes recordable on a storage medium or originally stored in a remote storage medium or a non-transitory machine-readable storage medium and downloaded via a network and to be stored in a local storage medium, so that the method described herein may be stored on such software on a storage medium using a general-purpose computer, a special-purpose processor, or programmable or special-purpose hardware. The storage medium may be a magnetic disk, an optical disk, a read-only memory, a random access memory, a flash memory, a hard disk, a solid-state disk, etc. Further, the storage medium may also include a combination of the above types of memories. It may be understood that the computer, the processor, the microprocessor controller, or the programmable hardware includes a storage component capable of storing or receiving software or computer codes, and when the software or computer codes are accessed and executed by the computer, the processor, or the hardware, the dialogue digital human generation method shown in the above embodiments is implemented.

A portion of the present disclosure may be applied as a computer program product, such as computer program instructions, which, when executed by a computer, may invoke or provide the method and/or technical solution according to the present disclosure through operations of the computer. Those skilled in the art should understand that the computer program instructions may be stored in a computer-readable medium in a form including, but not limited to, a source file, an executable file, an installation package file, etc., and accordingly, the computer program instructions may be executed by the computer in a manner including, but not limited to, the computer directly executing the instructions, or the computer compiling the instructions and then executing the corresponding compiled program, or the computer reading and executing the instructions, or the computer reading and installing the instructions and then executing the corresponding installed program. Here, the computer-readable medium may be any available computer-readable storage medium or communication medium accessible by the computer.

Although the embodiments of the present disclosure are described in conjunction with the drawings, those skilled in the art may make various modifications and variations without departing from the spirit and scope of the present disclosure, and such modifications and variations fall within the scope defined by the appended

1. A dialogue digital human generation method, comprising:
displaying a digital human generation interface, wherein the digital human generation interface comprises a script material area, a preview area, and a generation area;
obtaining a target script material in response to a material adding operation generated in the script material area;
parsing material content of the target script material to obtain at least one dialogue character corresponding to the target script material and dialogue content corresponding to the at least one dialogue character, and displaying each of the dialogue characters and the dialogue content corresponding to the each of the dialogue characters in the script material area;
displaying a digital human corresponding to the dialogue character in the preview area; and
generating a target dialogue digital human matching the target script material according to the dialogue character and the dialogue content in response to a digital human synthesis operation generated in the generation area.

2. The method of claim 1, wherein the displaying each of the dialogue characters and the dialogue content corresponding to the each of the dialogue characters in the script material area comprises:
displaying, in a character display area of the script material area, a character identifier corresponding to the each of the dialogue characters; and
displaying, in a content display area of the script material area, the dialogue content corresponding to the each of the dialogue characters.

3. The method of claim 2, further comprising at least one of:
displaying, at a first preset position of the character identifier, description information of the character identifier; and displaying, at a second preset position of the script material area, a character dialogue parameter,
updating a dialogue character corresponding to the dialogue content in response to a character switching operation for the dialogue content; and
updating the dialogue content corresponding to a dialogue character in response to a modification operation for the dialogue content of the dialogue character.

4. The method of claim 1, further comprising:
deleting the dialogue content and retaining configuration for the dialogue character in response to a clear operation for the dialogue content; and
preferentially matching corresponding dialogue content for the retained dialogue character in response that a script material is parsed again.

5. The method of claim 1, wherein the script material area comprises a script adding control, and the obtaining a target script material in response to a material adding operation generated in the script material area comprises at least one of:
displaying a script material adding interface in response to a trigger operation for the script adding control, wherein the script material adding interface comprises at least one of a writing assistance control, a script library control, and a multimedia control;
displaying at least one candidate script material in response to a trigger operation for the script library control, and obtaining the target script material in response to a selection operation for the candidate script material; and
displaying a script editing page in response to a trigger operation for the writing assistance control, and generating the target script material according to a target script parameter determined by a script parameter editing operation in response to the script parameter editing operation generated in the script editing page; and
displaying at least one candidate multimedia material in response to a trigger operation for the multimedia control, obtaining a target multimedia material in response to a selection operation for the candidate multimedia material, and determining the target multimedia material as the target script material.

6. The method of claim 1, wherein in parsing the material content of the target script material, the method further comprises:
displaying, in the script material area, a parsing progress of the target script material and parsing prompt information.

7. The method of claim 1, further comprising:
verifying the parsed dialogue content and generating a verification result; and
in response that the verification result represents that the dialogue content comprises non-compliant content, generating prompt information for the non-compliant content.

8. The method of claim 1, wherein the script material area comprises a character adding control, and the method further comprises:
displaying a character configuration interface in response to a trigger operation for the character adding control, wherein the character configuration interface comprises a portrait configuration control, a background configuration control, and a voice-over configuration control;
displaying at least one candidate portrait in response to a trigger operation for the portrait configuration control, and determining a target portrait in response to a selection operation for the candidate portrait ;
displaying at least one candidate background in response to a trigger operation for the background configuration control, and determining a target background in response to a selection operation for the candidate background;
displaying at least one candidate voice-over in response to a trigger operation for the voice-over configuration control, and determining a target voice-over in response to a selection operation for the candidate voice-over; and
fusing the target portrait, the target background, and the target voice-over to create a digital human corresponding to the dialogue character.

9. The method of claim 8, further comprising at least one of:
in response that creation of a same dialogue character is detected, prohibiting the creation of the same dialogue character, and generating prompt information for creation of the same dialogue character,
displaying the character configuration interface in response to a selection operation for the dialogue character, wherein the character configuration interface comprises the portrait configuration control, the background configuration control, and the voice-over configuration control; and
obtaining an updated dialogue character in response to a character configuration modification generated in the character configuration interface, wherein the character configuration modification comprises at least one of an portrait modification, a background modification, and a voice-over modification.

10. The method of claim 1, wherein when the dialogue character is created for the first time, the script material area comprises a portrait initialization control, a background initialization control, and a voice-over initialization control, and the method further comprises:
displaying a portrait configuration interface in the character configuration interface in response to a trigger operation for the portrait initialization control, and performing portrait customization according to a target portrait parameter determined by a portrait parameter configuration operation in response to the portrait parameter configuration operation generated in the portrait configuration interface, to generate an initialization character portrait;
displaying a background configuration interface in the character configuration interface in response to a trigger operation for the background initialization control, and performing background customization according to a target background parameter determined by a background parameter configuration operation in response to the background parameter configuration operation generated in the background configuration interface, to generate an initialization background;
displaying a voice-over configuration interface in the character configuration interface in response to a trigger operation for the voice-over initialization control, and performing voice-over customization according to a target voice-over parameter determined by a voice-over parameter configuration operation in response to the voice-over parameter configuration operation generated in the voice-over configuration interface, to generate an initialization voice-over; and
obtaining the dialogue character created for the first time based on a fusion configuration of the initialization character portrait, the initialization background, and the initialization voice-over.

11. The method of claim 8, further comprising at least one of:
previewing an action of a current portrait in response to a trigger operation for the current portrait;
and
previewing a current background in response to a trigger operation for the current background;
in response to there being a selected portrait, combining the selected portrait with the current background for preview;
and
playing a current voice-over in response to a selection operation for the current voice-over, and displaying timbre attribute information corresponding to the current voice-over.

12. The method of claim 1, further comprising:
displaying a character state of the dialogue character according to different trigger operations in response to the different trigger operations generated for the dialogue character; and
editing the dialogue character in response to dialogue character editing operations generated in the different character states,
in response that a number of the dialogue characters reaches a first preset value, displaying, at a first preset position of the script material area, a character identifier corresponding to each of the dialogue characters in a preset manner; and
in response that the number of the dialogue characters reaches a second preset value, prohibiting deleting the dialogue characters.

13. The method of claim 1, wherein the displaying, in the preview area, the digital human corresponding to the dialogue character comprises:
obtaining currently triggered target dialogue content and a target dialogue character corresponding to the target dialogue content; and
displaying, in the preview area, a digital human corresponding to the target dialogue character.
preferably , the method further comprising:
obtaining an on-camera character corresponding to the currently triggered target dialogue content;
determining a target on-camera character corresponding to the target dialogue content in response to a switching operation for the on-camera character in the script material area; and
displaying, in the preview area, a digital human corresponding to the target on-camera character.

14. The method of claim 13, wherein the preview area comprises a layout control, a playback control, and a subtitle switch control, and the method further comprises at least one of:
switching a display layout of the preview area in response to a trigger operation for the layout control;
and controlling playback of an action of the target dialogue digital human in the preview area in response to a trigger operation for the playback control;
and displaying the dialogue content in the preview area or turning off display of the dialogue content in response to a trigger operation for the subtitle control.

15. The method of claim 13, further comprising at least one of:
playing an action video of the target dialogue digital human and displaying a video playback progress control;
jumping to a video frame specified by a progress adjustment operation in response to the progress adjustment operation generated on the video playback progress control;
and displaying a preview image of a video frame specified by a progress adjustment trigger operation in response to the progress adjustment trigger operation generated on the video playback progress control.

16. The method of claim 13, further comprising at least one of:
displaying corresponding state prompt information in the preview area based on a loading state of the digital human;
and in response that the digital human corresponding to the dialogue character is deleted, generating, in the preview area, prompt information indicating that the digital human does not exist.

17. The method of claim 1, further comprising at least one of:
in response to there being no target script material, displaying the preview area in a preset format, and displaying, at a third preset position of the preview area, prompt information prompting to add a material in the script material area, and
in response to a subtitle content adjustment operation generated in the generation area, displaying the dialogue content in the preview area according to a subtitle parameter determined by the subtitle content adjustment operation.

18. The method of claim 1, wherein the digital human generation interface comprises a material parameter area, and the material parameter area comprises a plurality of material controls; and the method further comprises:
displaying a candidate material in response to a trigger operation for the material control;
at least one of loading a selected target material into the preview area for display in response to a selection operation for the candidate material; and in response to a material adjustment operation generated in the generation area, displaying the target material in the preview area according to a material parameter determined by the material adjustment operation,
or, wherein in response to the target script material being a single-character script material, the method further comprises at least one of:
determining a target character parameter corresponding to the dialogue character in response to a switching operation for any one of parameters of a portrait, a background, and a voice-over of the dialogue character;
and creating a dialogue digital human corresponding to any line of the dialogue content in response to a character creation operation for the any line of the dialogue content.

19. An electronic device, comprising:
a memory and a processor, wherein the memory and the processor are communicatively connected to each other, the memory stores computer instructions, and the processor executes the computer instructions to perform a dialogue digital human generation method comprising:
displaying a digital human generation interface, wherein the digital human generation interface comprises a script material area, a preview area, and a generation area;
obtaining a target script material in response to a material adding operation generated in the script material area;
parsing material content of the target script material to obtain at least one dialogue character corresponding to the target script material and dialogue content corresponding to the at least one dialogue character, and displaying each of the dialogue characters and the dialogue content corresponding to the each of the dialogue characters in the script material area;
displaying a digital human corresponding to the dialogue character in the preview area; and
generating a target dialogue digital human matching the target script material according to the dialogue character and the dialogue content in response to a digital human synthesis operation generated in the generation area .

20. A non-transitory computer-readable storage medium, wherein the computer-readable storage medium stores computer instructions, and the computer instructions are used to cause a computer to perform a dialogue digital human generation method comprising:
displaying a digital human generation interface, wherein the digital human generation interface comprises a script material area, a preview area, and a generation area;
obtaining a target script material in response to a material adding operation generated in the script material area;
parsing material content of the target script material to obtain at least one dialogue character corresponding to the target script material and dialogue content corresponding to the at least one dialogue character, and displaying each of the dialogue characters and the dialogue content corresponding to the each of the dialogue characters in the script material area;
displaying a digital human corresponding to the dialogue character in the preview area; and
generating a target dialogue digital human matching the target script material according to the dialogue character and the dialogue content in response to a digital human synthesis operation generated in the generation area.
